(19) United States
(12) Patent Application Publication
(10) Pub. No.: US 2026/0330216 A1
(43) Pub. Date: Oct. 22, 2026

(54) HYBRID DEEP LEARNING FRAMEWORK FOR CONTINUOUS USER AUTHENTICATION BASED ON DEVICE SENSORS

(71) Applicants: Bandar ALOTAIBI, Tabuk (SA); Munif ALOTAIBI, Riyadh (SA)

(72) Inventors: Bandar ALOTAIBI, Tabuk (SA); Munif ALOTAIBI, Riyadh (SA)

(21) Appl. No.: 19/181,716

(22) Filed: Apr. 17, 2025

(51) Int. Cl. G06N 3/08; G06F 21/32; G06N 3/048

(52) U.S. Cl. CPC G06N 3/08; G06F 21/32; G06N 3/048

(57) ABSTRACT

A method for a hybrid deep learning framework for continuous user authentication based on device sensors. The method may comprise: receiving time-series data from a MotionSense dataset and a human activity recognition using smartphones (UCI HAR) generated by the device sensors; preprocessing the time-series data for feeding into a deep learning pipeline; utilizing a vision transformer (ViT) module to split or patch a temporal sequence into local segments; utilizing a multi-head attention (MHA) mechanism to learn temporal dependencies across the temporal sequence; combining ViT embeddings and MHA mechanism outputs into a unified sequence; feeding a unified sequence into a bidirectional long short-term memory (BiLSTM) layer; concatenating hidden states of the BiLSTM to form a final context vector; outputting class probabilities through the final context vector and a dense layer; and training a hybrid deep learning model to predict subject identification based on the class probabilities.

### BACKGROUND

In the digital era, mobile devices have become integral to daily life, facilitating communication, transactions, and access to sensitive information; however, this increasing reliance on mobile devices creates major security issues, especially in terms of ensuring that only authorized users can access these devices and their data. Traditional authentication methods, such as PINs, passwords, and biometrics, provide an initial layer of security but fail to offer continuous protection throughout a session. This limitation creates an opportunity for unauthorized access, for example, if a device is left unattended or compromised after the initial authentication. Static methods usually do not adapt efficiently to changing threats, leaving devices exposed if the attacker gains access to them after the initial login. This issue has created a need for more adaptive methods of verifying user identity.

Continuous authentication, which involves verifying the user's identity in real-time while the device is in use, has emerged as a promising solution to these concerns. Unlike conventional methods, continuous authentication leverages behavioral and physiological features, offering an unobtrusive and dynamic security mechanism. Among the various behavioral metrics available, power consumption patterns, touch gestures, and physical movements have shown great potential as unique identifiers for distinguishing legitimate users from intruders, enabling the detection of unauthorized device usage with high accuracy in a short amount of time. In particular, device sensors (e.g., accelerometers, gyroscopes, magnetometers) enable the real-time measurement of user motion and interaction patterns, yielding highly individualized profiles that can serve as continuous authentication signatures. Device sensor readings can also be viewed as behavioral biometrics because they capture an individual's distinctive motion patterns. Multiple studies have shown that users demonstrate unique gait signatures, micro-movements, or interaction styles that remain relatively stable within individuals while varying significantly among them. For instance, differences in stride length, device grip force, and hand tremors collectively serve as a personal motion fingerprint. These fine-grained distinctions are not purely random noise; they arise from each user's neuromuscular coordination, posture, and habitual interaction style. As a result, motion-based signals have been recognized as sufficiently consistent and discriminative to meet the criteria for biometric traits, namely, universality, uniqueness, permanence, and collectability, making them viable for continuous authentication.

There are various challenges associated with developing a reliable continuous authentication system, such as extracting local and global motion signatures. Several approaches concentrate on short-term features, such as high-level statistical patterns and sliding windows, which can neglect important temporal dependencies across user actions. Second, model architectures that rely on simpler pipelines can underfit the complexity of the data or are not flexible enough to integrate various sensor modalities. Third, many approaches struggle to adapt seamlessly across diverse user contexts (e.g., standing, walking, changing device orientation), impacting real-time performance. Recent advances in deep learning provide powerful techniques for processing complex data, including sensor signals. In particular, convolutional neural networks (CNNs) effectively learn local patterns, while transformers utilize a multi-head attention (MHA) mechanism to capture long-range dependencies. Long short-term memory (LSTM) and bidirectional long short-term memory (BiLSTM) architectures also improve sequence modeling by retaining important temporal context through gating mechanisms. Vision transformers (ViTs) adapt the transformer concept to image patches and can similarly be applied to sensor patches. These components act as flexible building blocks in a hybrid pipeline that integrates localized feature extraction (using CNN-like or ViT-like modules), global attention (through MHA), and temporal sequence learning (via BiLSTM).

Single-sensor approaches often yield a narrow perspective on user behaviors by focusing on only one type of signal (e.g., from an accelerometer) and thus missing complementary information from other data sources, such as gyroscopes or magnetometers. This limited coverage can lead to lower accuracy and poorer robustness when user behavior varies, such as walking versus jogging. Similarly, conventional machine learning methods typically rely on hand-crafted features or simpler models that do not fully capture the temporal complexity and interdependencies of sensor streams.

### SUMMARY

A hybrid deep learning framework for continuous user authentication based on device sensors may combine multiple sensors, automatic feature extraction, a multi-head attention (MHA), and bidirectional long short-term memory (BiLSTM) layers enhancing user motion representation, accuracy, resilience, and expandability for continuous device authentication, while addressing the limitations of single-sensor and traditional machine learning solutions.

According to at least one exemplary embodiment, a method for a hybrid deep learning framework for continuous user authentication based on device sensors is provided. The method may comprise: receiving time-series data from a MotionSense dataset and a human activity recognition using smartphones (UCI HAR), both of which are generated by the device sensors; preprocessing the time-series data to extract features configured for feeding into a deep learning pipeline; utilizing a vision transformer (ViT) module to split or patch a temporal sequence into local segments by using a 1D convolutional operator; utilizing a multi-head attention (MHA) mechanism to learn temporal dependencies across the temporal sequence; combining embeddings of the ViT module and outputs of the MHA mechanism into a unified sequence; feeding a unified sequence into a bidirectional long short-term memory (BiLSTM) layer; concatenating hidden states of the BiLSTM to form a final context vector; outputting class probabilities using a softmax activation function through the final context vector and a dense layer; and training a model for the hybrid deep learning framework using a sparse categorical cross-entropy loss function to predict subject identification based on the class probabilities.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1 is a flow chart of an exemplary method for a hybrid deep learning framework for continuous user authentication based on device sensors.

FIG. 2 is a flow chart of preprocessing time-series data.

FIGS. 3A and 3B show a comparison of training and validation loss and accuracy.

FIG. 3A shows accuracy according to a number of epochs performed and FIG. 3B shows loss according to a number of epochs performed.

FIGS. 4A and 4B show a comparison of training and validation loss and accuracy.

FIG. 4A shows accuracy according to a number of epochs performed and FIG. 4B shows loss according to a number of epochs performed.

FIG. 5A shows a confusion matrix for MotionSense and FIG. 5B shows a confusion matrix for UCI HAR.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many of the embodiments described herein are described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, a computer configured to perform the described action.

Many of the embodiments described herein are described in terms of sequences of actions to be performed by, for example, an Artificial Intelligence (AI) module or modules. It will be understood by those skilled in the art that the sequence of actions described herein can be embodied entirely within any form of AI or ML architecture such that execution of the sequence of actions enables the processor to perform the functionality described herein. Thus, the various aspects of the present invention may be embodied in a number of different forms, all of which have been contemplated to be within the scope of the claimed subject matter. For example, machine learning architectures include but are not limited to Artificial Neural Networks (ANNs), Multi-Layer-Perceptrons (MLPs), Support Vector Machines (SVMs), Recurrent Neural Networks (RNNs), Large Language Models (LLMs), transformers, decision trees, random forests, expert systems, mixture of experts models, ensemble models, diffusion models, and autoencoder models, to name a few. However, many other forms of AI and ML architectures that enable the processor to perform the same functionality have been considered.

It may generally be contemplated for any AI or machine learning architecture to be retrained according to the data processed herein, for example automatically or continuously retrained on a predetermined schedule or based on one or more triggers, such as based on one or more detected changes in the data.

It may be contemplated for execution of the sequence of actions contemplated to be undertaken by the AI or ML architecture to be based on data retrieved from any sensor contemplated herein, and for execution of the sequence of actions to include actuation of any of the one or more transducers contemplated herein.

In one or more exemplary embodiment a method for a hybrid deep learning framework for continuous user authentication based on device sensors may be provided.

In some embodiments a hybrid deep learning model for time-series classification may be disclosed. The hybrid deep learning model may be configured to differentiate which user produced a given sensor stream in a context of continuous authentication by combining elements from a vision transformer (ViT) module, multi-head attention (MHA) mechanisms, and bidirectional long short-term memory (BiLSTM) networks.

As used herein a MotionSense dataset may be understood to mean a collection of data that was originally assembled to classify human activities and is repurposed for subject identification in a continuous authentication framework.

As used herein a UCI HAR dataset may be understood to mean a collection of data that was originally intended for activity recognition and is equally suitable for investigating subject identification.

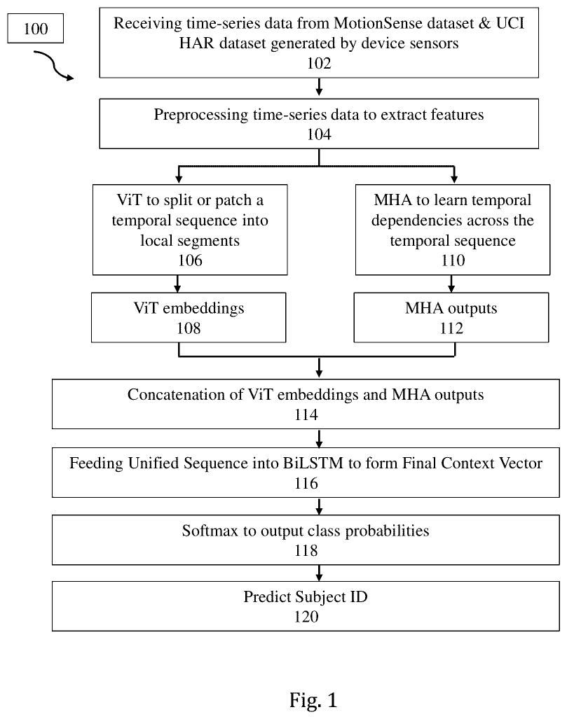

As shown in FIG. 1, an exemplary method for a hybrid deep learning framework for continuous user authentication based on device sensors 100 may be shown. In a first step 102 the hybrid deep learning model may utilize two different datasets, a MotionSense dataset and a human activity recognition using smartphones (UCI HAR) dataset, each representing a variety of human motion patterns that may be utilized for subject identification for continuous authentication. The MotionSense dataset and the UCI HAR dataset may include time-series data generated by one or more device sensors. The time-series data may include motion data. In some embodiments, as shown in Table 1, an exemplary example of attributes of the MotionSense dataset and the UCI HAR dataset so as to identify distinct individuals may be provided. A total of 24 participants (14 males and 10 females) may perform six activities (walking down stairs, walking up stairs, walking, jogging, sitting, standing) in 15 trials under uniform conditions. In other embodiments, for example, the motion data from the MotionSense dataset may be captured using a mobile device placed in participant's front pocket using a SensingKit framework. In some embodiments the MotionSense dataset may be generated by three core sensor modalities: Accelerometer (captures acceleration, including gravity); Attitude (measures orientation angles: pitch, roll, and yaw); and Gyroscope (records angular velocity).

TABLE 1

| Dataset | Participants | Activites | Features | Sampling Rate | Notes/Window Setup |
|---|---|---|---|---|---|
| MotionSense | 24 (14 M, 10 F) | 6 | 12 | 50 Hz | 15 trials per participant^{a} |
| UCI HAR | 30 (ages 19-48) | 6 | 561^{b} | 50 Hz | 2.56 s windows (50% overlap) |

In some embodiments the MotionSense dataset may be re-interpreted by preprocessing so as to reveal how user-specific motion signatures persist across various everyday tasks and conditions. The preprocessing of the MotionSense dataset may begin by confirming the integrity of the data and removing trials that were corrupt or incomplete. The motion data may then be segmented into short windows (e.g., (batch, nₛ×nₗ, n_{ƒ})), with each feature normalized for consistent ranges.

In another exemplary example, the motion data from the UCI HAR dataset may be captured using a device's accelerometer and gyroscope, for example, as shown in Table 1, a total of 30 volunteers (ages 19-48), each performing six daily activities (standing, sitting, lying down, walking, walking downstairs, and walking upstairs). The UCI HAR dataset may be adapted for user identification by relabeling each segment with subject identification. Each feature (pitch, roll, yaw, etc.) of the motion data from the UCI HAR dataset may be standardized or normalized for consistent scaling. The UCI HAR dataset may include various stationary postures, walking, and climbing stairs so as to illustrate the significant differences in motion data among participants.

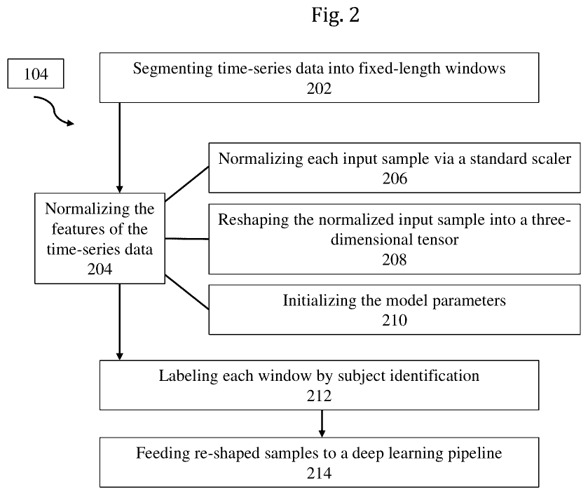

In a step 104 the MotionSense dataset and the UCI HAR dataset may be preprocessed using same settings. As shown in FIG. 2, in a step 202 the time-series data may first be segmented into fixed-length windows, in a step 204 normalized features, and in a step 212 labeled each window by subject identification. In a step 214 re-shaped samples may be then fed to a deep learning pipeline, where ViT-like patches, MHA mechanisms, and BiLSTM networks may collectively learn user-specific features.

In some embodiments regularization methods used in training for the MotionSense datasets and UCI HAR dataset may include: in a step 206 normalizing each input sample via a standard scaler, in a step 208 reshaping the normalized input sample into a three-dimensional tensor suitable for the hybrid model, and in a step 210 initializing the model parameters using default Keras initialization schemes for Conv1D, Dense, and LSTM layers, where Keras is a deep learning library for Python programming language.

In some embodiments an Adam optimizer may be employed at an appropriate learning rate, for example a learning rate of 0.001, to balance rapid convergence with stable updates. Early stopping may be applied to halt training when a validation loss stopped improving, thereby preventing overfitting and reducing unnecessary computation. In some embodiments the validation loss may be understood to mean a value of a loss function representing a model's error in classification during training. Model checkpoints may ensure that only best-performing weights are retained. In some embodiments dropout layers may be incorporated into the ViT and BiLSTM components. Recurrent dropout in the BiLSTM may be set to mitigate overfitting and encourage generalization. In some embodiments, for example, these choices may reflect a balance of computational feasibility, model complexity, and robustness to overfitting for the continuous authentication task.

In some embodiments the hybrid deep learning model may combine the ViT module, the MHA block, and the BiLSTM layer, architectures for processing and analyzing time-series data, so as to identify which subject produced a given time-series segment by learning distinctive motion signatures.

In some embodiments each sample, processed data, may be expressed as a matrix:

Xᵢ∈ [symbol] ^{T×F}, where T=nₛ×nₗ and F=n_{ƒ}

where T is a total number of time points in each window, nₛ is a number of sub-sequences (or chunks), and nₗ is a length of each chunk. Where F is a number of features (e.g., different sensor axes) per time point. Where i indexes a sample from 1 to N and N is a total number of time-series windows (samples) in the dataset. Where an integer label for the i th sample may be defined as:

λᵢ∈{0,1, . . . ,C−1}

where C is a total number of classes (i.e., a number of subjects to be identified). In some embodiments an entire set of trainable parameters in the hybrid deep learning model may be defined as Θ. The entire set of trainable parameters in the hybrid deep learning model may include convolution filters in the ViT, attention weights in the MHA block, and recurrent weights in the LSTM layers. Once the hybrid deep learning model outputs a probability vector pᵢ for sample i, predicted class label may be defined as:

\hat{λ}ᵢ=arg max(pᵢ).

Throught this work, a chosen loss function may be defined as [symbol] (⋅). In some embodiments a sparse categorical cross-entropy may be utilized so as to be particularly suitable for multi-class problems with integer labels.

In some embodiments a mapping function may be defined as:

ƒ:R^{T×F}→{0,1 . . . ,C−1}

and may be utilized to accurately identify a correct subject from each time-series segment. The hybrid deep learning model may be configured to minimize a loss function and a minimization of a loss function may be defined as:

$${min ℓ ( Θ )}_{Θ} , where ℓ ( Θ ) = - \frac{1}{N} {\sum }_{i = 1}^{N} log ( {p}_{i} , {λ}_{i} )$$

where pᵢ,λᵢ is a predicted probability (a λᵢth component of pᵢ) corresponding to a true subject label λᵢ. The hybrid deep learning model may be configured to adjust the parameter Θ to reduce the discrepancy between predictions and ground-truth labels by training the hybrid deep learning model via mini-batch gradient-based optimization and adjusting the parameter Θ.

In a step 106 a method to process may be configured to split or patch a temporal sequence using a 1D convolutional operator so as to adapt the ViT concept to time-series data. The method may convolve each Xᵢ with filters W_{c}, add a bias b_{c}, and apply a nonlinear ReLU activation σ(⋅). The method may be summarized by:

Z_{ρ}=σ(Xᵢ*W_{c}+b_{c})

where ρ is a local patch concept and * is a convolution operation. In some embodiments local segments Z_{ρ} may be then passed through a flatten operator F(⋅) and a dense layer with weights W_{d} plus bias b_{d}, followed by a dropout D(⋅) and another ReLU activation, and may be summarized by:

Zᵥ=D(σ(W_{d}F(Z_{ρ})+b_{d}))

where yielding a feature vector zᵥ∈ [symbol] ^{D} and D is a desired embedding dimension (e.g., 256). The ρ-based embeddings 108 capture local structure in the time-series vial analogy to the vision transformer. In some embodiments the temporal sequence may be time-series data segmented into fixed-length windows, normalized features, and labeled each window by subject identification.

In a step 110 the MHA mechanism may be utilized to learn temporal dependencies across the sequence. Each time-series sample Xᵢ may be transformed into three sets of vectors: queries G, keys J, and values E. The three sets of vectors may be defined as:

G=XᵢW_{G}, J=XᵢWⱼ, E=XᵢW_{E}

where each set is computed by multiplying Xᵢ by corresponding parameter matrices W_{G}, Wⱼ, and W_{E}, respectively. The weight matrices may be learnable parameters specific to each head. The MHA mechanism then may compute a weighted combination of E, with weights derived via a scaled dot product of G and J and summarized by:

$$A ( G , J , E ) = S ( \frac{G {J}^{T}}{\sqrt{{d}_{j}}} ) E$$

where S(⋅) is a softmax activation function and dⱼ is a dimension of keys and queries. In a multi-head setting, multiple such attentions h₁, h₂, . . . , h_{H} may be run in parallel (H heads) and summarized by:

M=[h₁; . . . ;h_{H}]W_{O}

where their outputs may be concatenated and projected by W_{O}. A residual connection may often bypass this projection, and the MHA mechanism may subsequently apply a layer normalization L(⋅) plus a feed-forward block so as to produce a final MHA output 110:

M_{ƒin}=L(D(σ(MₙW₁+b₁)

where Mₙ=L(M) is a normalized M.

In some embodiments the method may replicate zₑ across T time steps using a repeat operator R(⋅) to match a dimensionality of the MHA outputs and M_{ƒin} so as to combine the complementary strengths of ViT embeddings and MHA outputs. In a step 114 the ViT embeddings and MHA outputs may be concatenated into a unified sequence. The unified sequence may be defined as:

Z_{c}=[M_{ƒin};R(zₑ)]

In a step 116 subsequently Z_{c} may be fed into a bidirectional LSTM (BiLSTM) layer, denoted as B(⋅), which processes the sequence forwards and backwards in time:

$$\vec{{h}_{t}} , \vec{{h}_{t}} = B ( {Z}_{c} ) .$$

hidden states may be concatenated to form a final context vector h_{bi}. This vector may capture temporal information from both directions, making it especially powerful for identifying subtle user-specific patterns. In a step 118 a dense layer with weights W₂ and biases b₂ then may output class probabilities:

pᵢ=S(W₂h_{bi}+b₂)

where S(⋅) is the softmax activation function, and pᵢ is a predicted subject.

In a step 120 the hybrid deep learning model may be trained using the sparse categorical cross-entropy loss to predict subject identification:

$$ℓ ( Θ ) = - \frac{1}{N} {\sum }_{i = 1}^{N} ln ( {p}_{i} , {λ}_{i} )$$

where pᵢ,λᵢ is a probability assigned to the true subject λᵢ. The Adam optimizer may be utilized with an appropriate learning rate, for example with a learning rate of 0.001, which adaptively adjusts each parameter's learning rate in Θ. Training may proceed via mini-batch gradient-based updates until a validation performance converges or early stopping criterion is met. Through this process, the hybrid framework—consisting of p-based ViT embeddings, MHA, and bidirectional recurrent modeling—may learn distinctive user signatures for continuous authentication.

In some embodiments each input sample may be re-shaped to (batch, T, F) such that the ViT module and the MHA can process time-series data in a three-dimensional format. Standard callbacks such as early stopping and model checkpoints may manage overfitting and may select optimal weights automatically. Early stopping may halt training if the validation loss fails to improve for a specified number of epochs, while a model checkpoint may preserve a best model whenever a new performance milestone is reached. In some embodiments hyperparameters such as a batch size and number of epochs may be set to balance computational costs and model convergence. Final settings may be determined based on experiments, domain insights, and stable validation metrics.

In some embodiments each input sample, for example, may initially have a shape of (batch, 12, 1), where 12 represents the total time steps (n_steps×n_length, i.e., 4×3), and 1 indicates the single sensor dimension after preprocessing. A Keras tuner may be utilized to investigate important hyperparameters including parameters for the patch-extraction branch, such as ViT-like Conv1D filters, kernel size, stride, and the number of dense units. A number of heads in the MHA mechanism, a size of the LSTM layer, dropout rates, and overall learning rate and a batch size may be examined. In some embodiments an optimal configuration identified may include, for example, 256 LSTM units, a dropout rate of 0.4 for LSTM layers, a dropout rate of 0.2 for dense layers, and a learning rate of 0.001. In some embodiments, for example, for the ViT, 192 filters, a kernel size of 5, a stride of 2, 256 dense units, and four attention heads for the MHA may be utilized. The batch size may depend on the dataset, for example, for larger MotionSense dataset, a batch size of 512 may prove to be the most effective, while for smaller UCI HAR dataset, a batch size of 1024 may be utilized.

In some embodiments, for example, if a 1D convolution filter is used with 192 channels, a kernel size of 5, a stride of 2, and padding set to “same”, the time dimension may be reduced from 12 to 6, and an output shape of (batch, 6, 192) may be resulted. Flattening may result in either (batch, 6×192) or (batch, 1152), which is then projected to (batch, 256) through a dense layer with a dropout of 0.3, thus creating a ViT-like patch embedding. This embedding may be replicated across the original 12 steps to align with the time dimension, and may result in a shape of (batch, 12, 256). Simultaneously, the same input with the shape (batch, 12, 1) may be fed into an attention submodel. A MHA layer with four heads and a key dimension of 64 may be utilized. This layer may transform the data into a shape (batch, 12, 256) through internal dense layers, and may incorporate a dropout of 0.1 and layer normalization to enhance stability. Combining these two streams may result in the shape of (batch, 12, 512), effectively integrating local patch features from the ViT path with global dependencies from attention.

In some embodiments, for example, A bidirectional LSTM with 256 units, a dropout of 0.4, and a recurrent dropout of 0.2 may process this fused sequence, and may output a single vector of shape (batch, 512). A Dense layer with 256 units and a dropout rate of 0.2, followed by a Dense classification layer sized according to the number of subjects may be utilized by using a softmax activation function. In some embodiments, for example, sparse categorical cross-entropy as the loss function and the Adam optimizer for training may be utilized in experiments. The learning rate determined through hyperoptimization is 0.001 for both datasets, but the batch sizes may differ due to the sizes of the datasets: 512 for MotionSense and 1024 for UCI HAR. An 80-20 holdout scheme for each dataset may be utilized and the training may be stopped if the validation loss does not improve after 20 epochs, applying early stopping. This approach may prevent overfitting and may consistently select the best model across both datasets. The optimized hyperparameters may enhance the extraction of local patches, may enable multi-head global attention, and may improve LSTM-based temporal fusion, thereby resulting in greater accuracy compared to simpler pipelines.

In some embodiments the hybrid deep learning model may calculate classification accuracy by comparing each predicted label λᵢ with its true label λᵢ over all N samples. The classification accuracy defined as:

$$ψ = \frac{1}{N} {\sum }_{i = 1}^{N} \text{?} ( {\hat{λ}}_{i} = {λ}_{i} ) ,$$

where [symbol] (⋅) is an indicator function that returns 1 if \hat{λ}ᵢ matches λᵢ, and 0 otherwise. Although the accuracy suffices for a broad overview, additional metrics may yield deeper insights into class-level behaviors. In some embodiments confusion matrices may be helpful for quantifying the severity and distribution of misclassifications across different subjects.

In some embodiments the MotionSense datasets and UCI HAR datasets may be partitioned into training and testing splits based on subject identifications to assess a performance of the hybrid deep learning model. Internal validation splits on a training portion may be employed to tune hyperparameters, such as a learning rate, dropout probabilities, and number of attention heads. Once these hyperparameters are optimized, the hybrid deep learning model may be trained until early stopping criteria are met. At which point, the hybrid deep learning model's performance on the test set may be evaluated to measure its final generalization performance. Showing both training and validation loss and accuracy in one graph during a training process may allow for monitoring the model's ability to generalize to unseen subjects. Early stopping may ensure that irregularities of the training data are not excessively fitted, thus reducing risk of overfitting.

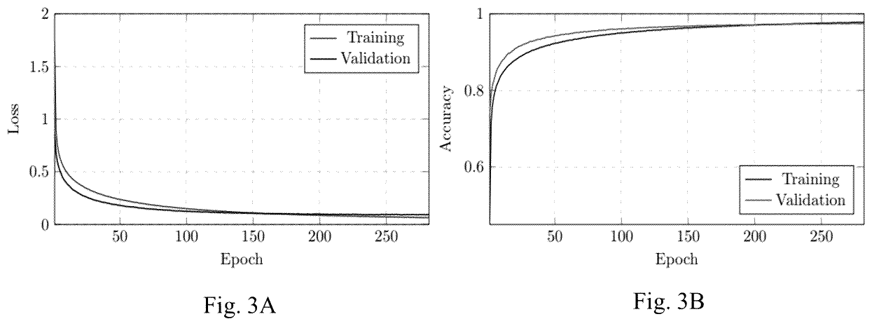

As shown in FIGS. 3A and 3B, in some embodiments an evaluation results of a model for the MotionSense dataset may be provided, where a horizontal axis corresponds to a number of epochs and a vertical axis corresponds to validation loss and validation accuracy, respectively. In some embodiments validation accuracy may be understood to mean percentage of correct predictions made by a model on the validation set. A Training logs may reveal a steady increase in validation accuracy, stabilizing around 96-97% in the mid to late epochs and a corresponding downward trend in validation loss. It may suggest that the model effectively captured user-specific motion signatures with minimal overfitting. In some embodiments an early stopping mechanism may further refine this process by halting training at a near-optimal epoch, sparing the model from unnecessary additional iterations.

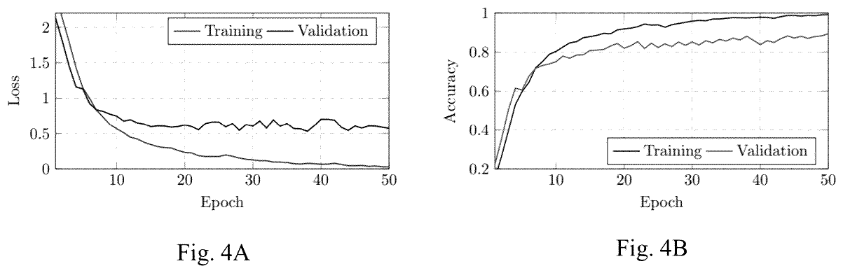

As shown in FIGS. 4A and 4B, in some embodiments an evaluation results of a model for the UCI HAR dataset may be provided. In some embodiments unlike the MotionSense dataset, the UCI HAR logs may show that the model typically converged in relatively fewer epochs after which the validation metrics remained stable or fluctuated mildly. As shown in FIGS. 3 and 4, in some embodiments these evaluation results may confirm the viability of the ViT, the MHA, and the BiLSTM design for subject identification tasks across both the MotionSense dataset and the UCI HAR dataset.

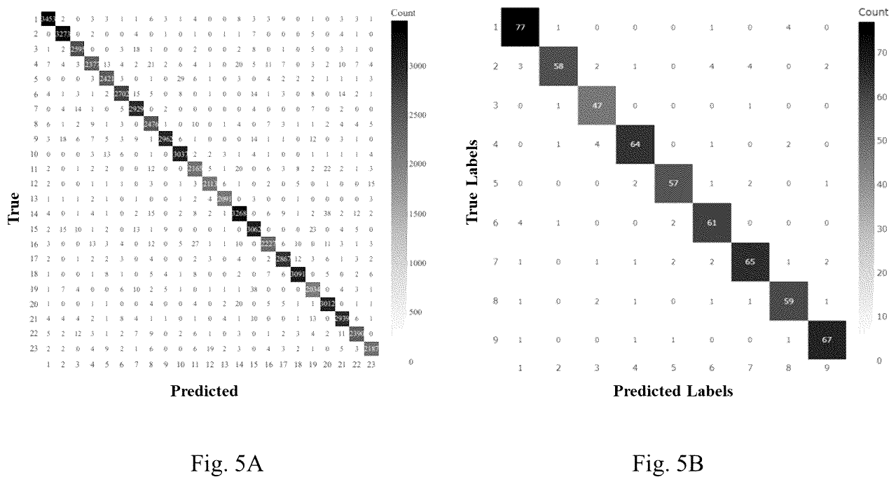

As shown in FIGS. 5(a) and 5(b), in some embodiments a confusion matrix for final subject identification task may be provided, where each row corresponds to a true subject and each column corresponds to a predicted subject. Darker diagonals indicate correct classifications, while off-diagonal cells reflect misclassifications. It may be observed that the vast majority of samples for each subject aligned with the main diagonal, confirming that the model captured individual-specific features for most participants. This matrix may support quantitative results, demonstrating the model's strong ability to differentiate unique motion signatures.

In some embodiments a hybrid model combining CNN and LSTM layers may be implemented to further validate the proposed hybrid deep learning model using same experimental settings for multiple epochs, for example 100 epochs, on the MotionSense dataset. The proposed hybrid deep learning model may achieve a significantly lower loss, and a higher accuracy compared to the hybrid model combining CNN and LSTM layers, for example, this reproduced approach, combining CNN and LSTM layers, attained a final loss of 0.2161 and an accuracy of 0.9295, while the proposed ViT, MHA, and BiLSTM model achieved a significantly lower loss of 0.1254 and higher accuracy of 0.9607, demonstrating its superior efficacy of the proposed hybrid architecture in extracting and leveraging user-specific motion signatures. The ViT-like patching and the MHA may capture local and global dependencies more effectively, while the BiLSTM component allows for robust sequence modeling. These results may confirm that the proposed method outperformed the CNN and LSTM baseline in subject identification tasks on the MotionSense dataset, underscoring its value for continuous authentication scenarios.

In some embodiments the proposed hybrid deep learning model may be compared with several baseline approaches—three traditional machine learning methods (Logistic Regression, KNN, and Naive Bayes) and two deep learning architectures (an LSTM with 64 neurons and a CNN model). As shown in Table 3, in some embodiments, in the MotionSense dataset, KNN and the LSTM may achieve relatively high accuracies, for example, about 93.8% and about 93.7%, respectively, while the CNN obtains about 92.5% and results of Naive Bayes and Logistic Regression are comparatively lower (about 38.7% and about 57.4%, respectively). The proposed hybrid deep learning model may typically outperform these baselines, for example, with an accuracy of 97.51%. In UCI HAR, the proposed hybrid deep learning model may outperform these baselines, for example, with an accuracy of 89.37%.

TABLE 2

| Model | MotionSense Accuracy | UCI HAR Accuracy |
|---|---|---|
| Logistic Regression | 0.5743 | 0.8229 |
| K-Nearest Neighbors | 0.9384 | 0.8100 |
| Naive Bayes | 0.3866 | 0.3060 |
| LSTM | 0.9374 | 0.7649 |
| CNN | 0.9251 | 0.8019 |
| Proposed Model | 0.9751 | 0.8937 |

In some embodiments these findings may emphasize that although single architectures may perform reasonably well, collaboration offered by the proposed hybrid deep learning model may provide further gains in complex, multi-subject classification settings.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for a hybrid deep learning framework for continuous user authentication based on device sensors, comprising:
receiving time-series data from a MotionSense dataset and a human activity recognition using smartphones (UCI HAR), both of which are generated by the device sensors;
preprocessing the time-series data to extract features configured for feeding into a deep learning pipeline;
utilizing a vision transformer (ViT) module to split or patch a temporal sequence into local segments by using a 1D convolutional operator;
utilizing a multi-head attention (MHA) mechanism to learn temporal dependencies across the temporal sequence;
combining embeddings of the ViT module and outputs of the MHA mechanism into a unified sequence;
feeding a unified sequence into a bidirectional long short-term memory (BiLSTM) layer;
concatenating hidden states of the BiLSTM to form a final context vector;
outputting class probabilities using a softmax activation function through the final context vector and a dense layer; and
training a hybrid deep learning model using a sparse categorical cross-entropy loss function to predict subject identification based on the class probabilities.

2. The method of claim 1, wherein the MotionSense dataset generated by:
an accelerometer that captures acceleration, including gravity;
an attitude that measures orientation angles, including pitch, roll, and yaw; and
a gyroscope that records angular velocity.

3. The method of claim 1, wherein preprocessing the time-series data comprises:
segmenting time-series data into fixed-length windows;
normalizing the features of the time-series data;
labeling each window by subject identification; and
feeding re-shaped samples to a deep learning pipeline.

4. The method of claim 3, wherein normalizing the features of time-series data comprises:
normalizing each input sample via a standard scaler;
reshaping the normalized input sample into a three-dimensional tensor suitable for the hybrid deep learning model; and
initializing the model parameters using default Keras initialization schemes for Conv1D, Dense, and LSTM layers.

5. The method of claim 1, wherein the temporal sequence is time-series data segmented into fixed-length windows, normalized features, and labeled each window by subject identification, and wherein the 1D convolutional operator is used to patch the time-series data and create ViT-like patch embeddings.

6. The method of claim 1, wherein utilizing MHA mechanism comprises:
transforming each time-series data into three sets of vectors: G, J, and E;
learning weight matrices of the three sets of vectors; and
computing a weighted combination of E, with weights derived via a scaled dot product of G and J,
wherein the three sets of vectors comprises queries G, keys J, and values E.

7. The method of claim 1, wherein feeding the unified sequence comprises:
processing the sequence forwards and backwards in time.

8. The method of claim 1, wherein the final context vector captures temporal information from both directions to identify subtle user-specific patterns.

9. The method of claim 1, wherein the class probabilities correspond to subject identification.

10. The method of claim 1, wherein training the model comprises:
proceeding mini-batch gradient-based updates until a validation performance converges or an early stopping criterion is met;
applying early stopping with a patience value to halt training when the validation loss stops improving;
utilizing model checkpoints to preserve the best-performing weights based on validation metrics; and
optimizing hyperparameters such as the learning rate, batch size, dropout rates, and the number of LSTM units through a Keras tuner.

11. A non-transitory computer readable medium with computer executable instructions stored thereon configured to be executed by a processor to perform a method for hybrid deep learning framework for continuous user authentication based on device sensors, comprising:
receiving time-series data from a MotionSense dataset and a human activity recognition using smartphones (UCI HAR), both of which are generated by the device sensors;
preprocessing the time-series data to extract features configured for feeding into a deep learning pipeline;
utilizing a vision transformer (ViT) module to split or patch a temporal sequence into local segments by using a 1D convolutional operator;
utilizing a multi-head attention (MHA) mechanism to learn temporal dependencies across the temporal sequence;
combining embeddings of the ViT module and outputs of the MHA mechanism into a unified sequence;
feeding a unified sequence into a bidirectional long short-term memory (BiLSTM) layer;
concatenating hidden states of the BiLSTM to form a final context vector;
outputting class probabilities using a softmax activation function through the final context vector and a dense layer; and
training a hybrid deep learning model using a sparse categorical cross-entropy loss function to predict subject identification based on the class probabilities.

12. The non-transitory computer readable medium of claim 11, wherein preprocessing the time-series data comprises:
segmenting time-series data into fixed-length windows;
normalizing the features of the time-series data;
labeling each window by subject identification; and
feeding re-shaped samples to a deep learning pipeline.

13. The non-transitory computer readable medium of claim 12, wherein normalizing the features of time-series data comprises:
normalizing each input sample via a standard scaler;
reshaping the normalized input sample into a three-dimensional tensor suitable for the hybrid deep learning model; and
initializing the model parameters using default Keras initialization schemes for Conv1D, Dense, and LSTM layers.
